(19) United States
(12) Patent Application Publication
(10) Pub. No.: US 2024/0385547 A1
(43) Pub. Date: Nov. 21, 2024

(54) EXTERNAL ADDITIVE FOR TONER

(71) Applicant: Hewlett-Packard Development Company, L.p., Spring, TX (US)

(72) Inventors: Seyoung Yoon, Seongnam Si (KR); Kyeonghwan Choi, Seongnam Si (KR); Seungsik Woo, Seongnam Si (KR)

(21) Appl. No.: 18/576,598

(22) PCT Filed: Jul. 6, 2021
(86) PCT No.: PCT/US2021/040491

§ 371 Date: Jan. 4, 2024

(51) Int. Cl. G03G 9/097; G03G 9/08

(52) U.S. Cl. CPC G03G 9/09708; G03G 9/0819; G03G 9/09725; G03G 9/09775; G03G 2215/0604

(57) ABSTRACT

An external additive for a toner is described. An example external additive comprises tin oxide, aluminum oxide, and a silica-polymer composite.

### BACKGROUND

The shape and surface control technology of toners are to cope with the trend of full color, high speed, and high quality of printers, as well as a small and light printer operating in a low cost and eco-friendly way.

### DETAILED DESCRIPTION

Surface characteristic of toner particles affects the quality of the toner particles, such as charging uniformity, charging stability, transferability, and cleaning ability. One of the factors is an external additive attached to the surface of the toner particles.

According to an example of the present disclosure, an external additive for a toner is provided. The external additive comprises tin oxide, aluminum oxide, and silica-polymer composite.

The external additives are attached to the surfaces of the core particles of the toner. The term “external” means a material to be added to the core particle and attached to the surface of the core particles of the toner. One of the main functions of the external additives is to prevent the toner particles from sticking together thereby maintaining flowability of toner particles. For this function, some external additives can comprise silica or titanium dioxide (TiO₂). However, in examples of the present disclosure, an external additive comprising tin oxide, aluminum oxide, and silica-polymer imparts superior properties without using titanium dioxide.

In the present disclosure, tin oxide is provided as one of the components for composing the external additives. Tin oxide can provide a charge control of the toner and charging stability according to the environment. Tin oxide may also provide improving transfer property. Tin oxide may supplement the secondary problems of deteriorating the charging stability caused by the single or excessive use of aluminum oxide.

In an example of the present disclosure, tin oxide may be used as tin oxide (SnO) also named stannous oxide, or may be used as tin dioxide (SnO₂) also named tin dioxide or stannic oxide. In an example, tin oxide may be tin dioxide.

Tin oxide may be a hydrophobized tin dioxide.

In an example, tin oxide may be modified with a hydrophobic surface treatment. Through the hydrophobic surface treatment of the tin oxide, hydrophobized tin dioxide may be used. The hydrophobicity may be adjusted accordingly. When the tin oxide is modified, the hydrophobicity may be in a range between 10% and 90%.

The hydrophobic surface treatment may be conducted by using an agent. Examples of the agent may include, but are not limited to, silicone oils, silanes, siloxanes or silazane. In detailed examples, the agent may be hexamethyldimethyl siloxame (HMDS), polydimethyl siloxane (PDMS), diethyldimethyl siloxane (DDS), dimethyltrimethoxy silane (DTMS) or a combination thereof.

In an example, an average primary particle diameter D50 of the tin oxide may be from about 10 nm to about 100 nm, from about 10 nm to about 80 nm, from about 10 nm to about 50 nm, or from about 15 nm to about 35 nm. In this regard, the average primary particle diameter D50 refers to a diameter at which the cumulative volume of the tin oxide particles corresponds to 50% of the total cumulative volume of the tin oxide in a cumulative volume curve of the tin oxide particles. By using the tin oxide satisfying the foregoing range, charging stability according to the environment is further improved.

The amount of tin oxide may be included in the external additive, may be, for example, from about 0.01 to about 10 parts by weight, from about 0.1 to about 3.0 parts by weight, from about 0.5 to about 2.0 parts by weight based on 100 parts by weight of the external additives.

In the present disclosure, aluminum oxide is provided as one of the components for composing the external additive. Aluminum oxide is also named alumina or aloxite, the chemical formula is AL₂O₃. Aluminum oxide can provide charge control of the toner and charging stability according to the environment. It can also prevent or reduce contamination by permitting reducing use of tin oxide.

In an example, an average primary particle diameter D50 of the aluminum oxide may be from about 7 nm to about 80 nm, from about 7 nm to about 50 nm, from about 10 nm to about 30 nm, from about 10 nm to about 20 nm, from about 11 nm to about 15 nm, and from about 12 nm to about 14 nm. In this regard, the average primary particle diameter D50 refers to a diameter at which the cumulative volume of the aluminum oxide particles corresponds to 50% of the total cumulative volume of the aluminum oxide in a cumulative volume curve of the aluminum oxide particles. By using aluminum oxide satisfying the foregoing range, the total amount of external additives can be effectively reduced while maintaining an excellent property of the external additives.

The amount of aluminum oxide included in the external additives, may be, for example, from about 0.01 to about 2 parts by weight, from about 0.03 to about 1.5 parts by weight, or from about 0.05 to about 0.8 parts by weight based on 100 parts by weight of the external additives.

According to an example of the present disclosure, by using a suitable amount of tin oxide and aluminum oxide in combination, charging control can be achieved more effectively. In addition, disadvantages of using tin dioxide and aluminum oxide separately may be compensated. Indeed, if the amount of tin oxide is used in excess, it may cause toner scattering contamination of the cartridge due to lowering charging ability and have a risk of image contamination. In contrast, when aluminum oxide is used in excess, the charging stability in the LL (low-temperature) environment and the HH (high-temperature) environment may deteriorate. However, the combination of tin oxide and aluminum oxide may provide a solution to these disadvantages.

Due to comprising the tin oxide and the aluminum oxide together, the external additive according to the present disclosure may have high performance without comprising titanium dioxide (TiO₂).

In the present disclosure, a silica-polymer composite is provided as one of the components for composing the external additives. The silica-polymer composite may improve durability and transfer efficiency. Improved durability and enhanced transfer efficiency lead to lengthening the life of the toner.

A silica-polymer composite is a material combining inorganic silica and organic polymers. This inorganic-organic hybrid composite contributes to obtaining properties of the external additives. A general silica-polymer composite may be used for the silica-polymer composite of the present disclosure. Examples of the silica-polymer composite may include ATLAS™ SILICA COMPOSITE from CABOT. Examples of the silica-polymer composite may include hydrophobic silica and polymer in spheroid particles of approximately 100 nm in average primary particle diameter D50.

In an example, an average primary particle diameter D50 of silica-polymer composite may be about 120 nm or less, about 115 nm or less, and about 111 nm or less. In this regard. the average primary particle diameter DSO refers to a diameter at which the cumulative volume of the silica-polymer composite corresponds to 50% of the total cumulative volume of the silica-polymer composite in a cumulative volume curve of the silica-polymer composite.

The amount of silica-polymer composite included in the external additives, may be, for example, from about 0.01 to about 5 parts by weight, from about 0.3 to about 4 parts by weight, or from about 0.6 to about 3 parts by weight based on 100 parts by weight of the external additives.

In an example, the external additive may further include an inorganic component such as silica. Examples of silica may include, but are not limited to, fumed silica and/or sol-gel silica. The silica may comprise a fumed silica and a sol-gel silica. For example, silica may be used in particle form. The silica may give excellent environmental charging stability to the external additives.

When the fumed silica is provided, it may be treated with surface modification. By treating with hydrophobic surface treatment, hydrophobic surface-treated fumed silica may be used.

Variable sizes of the silica particles may be used. In an example, the silica particle may include large-diameter silica particles, small-diameter silica particles and particles in combination thereof. An average primary particle diameter D50 of the large-diameter silica particles may be from about 50 nm to about 200 nm, and an average primary particle diameter D50 of the small-diameter silica particles may be from about 5 nm to about 50 nm.

The external additive may be attached to the surface of the core particle. In an example, a powder mixing apparatus, Henshell mixer, a V-shape mixer, a ball mill, or/and Nauta mixer may be used to attach the external additive to the surface of the core particle of the toner.

According to the present disclosure, the external additive can adjust the charge control and high resolution and high quality image may be obtained by comprising tin oxide and aluminum oxide together. Moreover, the toner comprising the external additives may obtain stable durability. This effect can be obtained by using tin oxide, and aluminum oxide and silica-polymer composite without using titanium oxide.

According to another example of the present disclosure, a toner is provided. The toner comprises a core particle and an external additive attached to a surface of the core particle. The core particle includes a binder resin, a colorant, and a releasing agent, and the external additive includes tin dioxide, aluminum oxide, and a silica-polymer composite.

Examples of the binder resin may include, but are not limited to, a styrenic resin, an acrylic resin, a vinyl resin or polyolefin resin, a polyether-based polyol resin, a phenolic resin, a silicone resin, a polyester resin, an epoxy resin, a polyimide resin, a polyurethane resin, a polybutadiene resin, or any mixture thereof.

Examples of the styrenic resin may include, but are not limited to, polystyrene: a homopolymer of a styrenic monomer such as poly-p-chlorostyrene or polyvinyltoluene; a styrene-based copolymer such as a styrene-p-chlorostyrene copolymer, styrenevinyltoluene copolymer, a styrene-vinyl naphthalene copolymer, a styrene-acrylic acid ester copolymer, a styrene-methacrylic acid ester copolymer, a styrene-methyl achloromethacrylate copolymer, a styrene-acrylonitrile copolymer, a styrene-vinyl methyl ether copolymer, a styrene-vinyl ethyl ether copolymer, a styrene-vinyl methyl ketone copolymer, a styrene-butadiene copolymer, a styrene-isoprene copolymer, or a styrene-acrylonitrile-indene copolymer, or any mixture thereof.

Examples of the acrylic resin may include, but are not limited to, a polymer of acrylic acid, a polymer of methacrylic acid, a polymer of methyl methacrylate, a polymer of methyl α-chloromethacrylate, or any mixture thereof.

Examples of the vinyl resin or polyolefin resin may include, but are not limited to, polyvinyl chloride, polyethylene, polypropylene, polyacrylonitrile, polyvinyl acetate, or any mixture thereof.

The polyester resin may be prepared via reaction between an aliphatic, alicyclic, or aromatic polybasic carboxylic acid or alkyl ester thereof and polyhydric alcohol via direct esterification or trans-esterification. Examples of the polybasic carboxylic acid may include phthalic acid, isophthalic acid, terephthalic acid, tetrachlorophthalic acid, chlorophthalic acid, nitrophthalic acid, p-carboxyphenylacetic acid, p-phenylene-2-acetic acid, m-phenylenediglycolic acid, p-phenylenediglycolic acid, ophenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and/or cyclohexane dicarboxylic acid. Also, in addition to the dicarboxylic acid, a polybasic carboxylic acid such as trimellitic acid, pyromellitic acid, naphthalene tricarboxylic acid, naphthalene tetracarboxylic acid, pyrene tricarboxylic acid, and pyrene tetracarboxylic acid may be used. Also, derivatives of a carboxylic acid in which the carboxylic group thereof is reacted to form an anhydride, oxychloride, or ester group may be used. Among them, terephthalic acid or lower esters thereof, diphenyl acetic acid, cyclohexane di-carboxylic acid, or the like may be used. The lower ester refers to an ester of aliphatic alcohol having one to eight carbon atoms. Examples of the polyhydric alcohol may include an aliphatic diol such as ethylene glycol, diethylene glycol, triethylene glycol, propylene glycol, butane diol, hexane diol, neopentyl glycol, or glycerine; an alicyclic diol such as cyclohexane diol, cyclohexane dimethanol, or hydrogen-added bisphenol A: and an aromatic diol such as ethylene oxide adduct of bisphenol A or propylene oxide adduct of bisphenol A. One or more than one of the polyhydric alcohol may be used. Among these polyhydric alcohols, an aromatic diol and an alicyclic diol may be used. For example, an aromatic diol may be used. In addition, a polyhydric alcohol having three or more-OH groups, such as glycerin, trimethylol propane, or pentaerythritol may be used together with the diol to have a cross-linked structure or a branched structure to increase fixability or fusability of the toner.

A number average molecular weight of the binder resin may be in the range of about 700 to about 1,000,000 g/mol or about 10,000 to about 500,000 g/mol. The binder resin used in the present disclosure may include a combination of a high molecular weight binder resin and a low molecular weight binder resin in an appropriate ratio. A number average molecular weight of the high molecular weight binder resin may be, for example, from about 100,000 to about 500,000 g/mol, and a number average molecular weight of the low molecular weight binder resin may be, for example, from about 1,000 to about 100,000 g/mol. The two types of binder resins having different molecular weights may have independent functions. The low molecular weight binder resin has little molecular chain entanglements, thereby contributing to fusability and gloss. On the contrary, the high molecular weight binder resin may maintain a certain level of elasticity even at a high temperature due to many molecular chain entanglements, thereby contributing to anti-hot offset properties.

The colorant may be, for example, a black colorant, a yellow colorant, a magenta colorant, a cyan colorant, or any combination thereof.

For example, the black colorant may be carbon black, aniline black, or any mixture thereof.

For example, the yellow colorant may be a condensed nitrogen compound, an isoindolinon compound, an anthraquinone compound, an azo metal complex, an allyl imide compound, or any mixture thereof. More particularly, the yellow colorant may be, but is not limited to, “C.I. Pigment Yellow” 12, 13, 14, 17, 62, 74, 83, 93, 94, 95, 109, 110, 111, 128, 129, 147, 168, or 180.

For example, the magenta colorant may be a condensed nitrogen compound, an anthraquinone compound, a quinacridone compound, a base dye lake, a naphthol compound, a benzoimidazole compound, a thioindigo compound, a perylene compound, or any mixture thereof. More particularly, the magenta colorant may be, but is not limited to, “C.I. Pigment Red” 2, 3, 5, 6, 7, 23, 48:2, 48:3, 48:4, 57:1, 81:1, 122, 144, 146, 166, 169, 177, 184, 185, 202, 206, 220, 221, or 254.

For example, the cyan colorant may be a copper phthalocyanine compound or a derivative thereof, an anthraquinone compound, a base dye lake, or any mixture thereof. More particularly, the cyan colorant may be, but is not limited to, “C.I. Pigment Blue” 1, 7, 15, 15:1, 15:2, 15:3, 15:4, 60, 62, or 66.

The amount of the colorant included in the core particle may be, for example, from about 0.1 parts by weight to about 20 parts by weight, for example, from about 2 parts by weight to about 10 parts by weight, based on 100 parts by weight of the binder resin, without being limited thereto.

Examples of the releasing agent may include, but are not limited to, a polyethylene-based wax, a polypropylene-based wax, a silicone-based wax, a paraffin-based wax, an ester-based wax, a carnauba-based wax, a metallocene-based wax, or any mixture thereof.

The releasing agent may have, for example, a melting point of from about 50° C. to about 150° C., without being limited thereto. The amount of the releasing agent included in the core particle may be, for example, from about 1 part by weight to about 20 parts by weight, or from about 1 part by weight to about 10 parts by weight, based on 100 parts by weight of the binder resin. The releasing agent may prevent the toner particles from sticking to a heating roller of a fixing device.

The core particles may be prepared by, for example, a pulverization process, an aggregation process, or a spraying process. The pulverization process may be performed by, for example, pulverizing after melting and mixing a binder resin, a colorant, and a releasing agent. The aggregation process may be performed by, for example, mixing a binder resin dispersion, a colorant dispersion, and a releasing agent dispersion; aggregating these particles of the binder resin, the colorant, and the releasing agent; and combining the resulting aggregates.

An average primary particle diameter of the core particles may be, but is not limited to, from about 4 μm to about 20 μm or from about 5 μm to about 10 μm.

A shape of the core particles is also not particularly limited. As the shape of the core particles is closer to a sphere, charging stability of the toner and dot reproducibility of a print image may be enhanced. For example, the core particles may have a sphericity in a range of, for example, about 0.90 to about 0.99.

The external additive is attached to the core particle. The external additive includes a tin oxide, aluminum oxide, and silica-polymer composite. The characteristics of the tin oxide, the aluminum oxide, and the silica-polymer composite are as described above. The external additive may further include inorganic particles such as silica. The silica may be provided as fumed silica particles, sol-gel silica particles, or combination thereof.

In an example, average primary particle diameters D50 of the tin oxide, the aluminum oxide and the silica-polymer composite in the toner particles may range as described above. In other words, an average primary particle diameter D50 of the tin oxide may be from about 10 nm to about 100 nm. An average primary particle diameter D50 of the aluminum oxide may be from about 7 nm to about 80 nm. An average primary particle diameter D50 of silica-polymer composite may be from about 110 nm or less.

The amount of the external additive may be in range of about 1.5 to about 7 parts by weight, or about 2 to about 5 parts by weight, based on 100 parts by weight of toner to which the external additive is not added. When the amount of the external additive is greater than or equal to about 1.5 parts by weight based on 100 parts by weight of toner to which the external additive is not added, caking that occurs as toner particles adhere to each other due to an inter-particle agglomeration force is reduced or prevented, and the amount of charge applied may be stable. When the amount of the external additive is less than or equal to about 7 parts by weight based on 100 parts by weight of toner to which the external additive is not added, the external additive may not contaminate a roller of an image forming apparatus. According to the present disclosure, the amount of the external additives can be minimized by comprising tin oxide, aluminum oxide, and silica-polymer composite as active components.

In order to control and determine a property of the toner of the present disclosure, X-ray fluorescence intensity can be used. X-ray fluorescence intensity of each element composing the external additives of the toner can be measured by using a wavelength dispersive X-ray fluorescence (WD-XRF) spectrometry.

In an example of the present disclosure, the toner may have certain X-ray fluorescence intensity (unit: kcps) when measured by Wavelength dispersive X-ray fluorescence (WD-XRF) spectrometry. In particular, when the plurality of the toner particles are measure by X-ray fluorescence (WD-XRF) spectrometry, a ratio of an X-ray fluorescence intensity may satisfy the following condition (1):

$$0.4 \leq [ Sn ] / [ Al ] \leq 64 \qquad ( 1 )$$

wherein [Sn] is an X-ray fluorescence intensity (unit: kcps) of tin oxide measured by the WD-XRF spectrometry of the plurality of the toner particles, [Al] is an X-ray fluorescence intensity (unit: kcps) of aluminum oxide measured by the WD-XRF spectrometry of the plurality of the toner particles.

In another example, when the plurality of the toner particles are measured by X-ray fluorescence (WD-XRF) spectrometry, a ratio of an X-ray fluorescence intensity (unit: kcps) may satisfy following condition (2):

$$0.07 \leq [ Sn ] / [ Si ] \leq 3.2 \qquad ( 2 )$$

wherein, [Sn] is an X-ray fluorescence intensity (unit: kcps) of tin oxide [Sn], and [Si] is an X-ray fluorescence intensity (unit: kcps) of silica.

In still another example, when the plurality of the toner particles are measured by X-ray fluorescence (WD-XRF) spectrometry, a ratio of an X-ray fluorescence intensity (unit: kcps) may satisfy following condition (3):

$$0.01 \leq [ Al ] / [ Si ] \leq 0.81 \qquad ( 3 )$$

wherein, [Al] is an X-ray fluorescence intensity (unit: kcps) of aluminum oxide, and [Si] is an X-ray fluorescence intensity (unit: kcps) of silica.

In an example of the present disclosure, a surface of the toner may be modified by controlling a ratio of an X-ray fluorescence intensity between [Sn] and [Al], between [Sn] and [Si], or between [Al] and [Si] as described above. The quality of the toner may be satisfactory in view of durability, flowability, charging stability, and charging uniformity when at least one of the above conditions is met.

By satisfying two of the above conditions (1), (2), and (3), the performance of the toner may be further enhanced in view of durability, flowability, charging stability, and charging uniformity. When the toner meets all conditions (1), (2), and (3), further excellent quality of toner may be realized whereby the printer may have a long life, respond to high speed as well as satisfy high image quality.

In an example of the present disclosure, a toner may further comprise silica. The kinds and amounts of silica are as described in the present disclosure.

According to another example of the present disclosure, an example cartridge for developing an electrostatic latent image is provided. The cartridge comprises a toner, and the toner is a toner for developing an electrostatic latent image. The cartridge may be detachable from an image forming apparatus.

The amount of the external additive may be in range of about 1.5 to about 7 parts by weight, or about 2 to about 5 parts by weight, based on 100 parts by weight of toner to which the external additive is not added. When the amount of the external additive is greater than or equal to about 1.5 parts by weight based on 100 parts by weight of toner to which the external additive is not added, caking that occurs as toner particles adhere to each other due to an inter-particle agglomeration force is prevented, and the amount of charge applied may be stable. When the amount of the external additive is less than or equal to about 7 parts by weight based on 100 parts by weight of toner to which the external additive is not added, the external additive may not contaminate a roller of an image forming apparatus.

Hereinafter, the external additives and the toner comprising the external additives according to an example of the present disclosure will be described in detail. However, these examples and comparative examples are not intended to limit the scope of the present disclosure.

### EXAMPLES

Various external additives prepared with and having different particle sizes and amount of tin oxide, aluminum oxide and silica-polymer composite as Examples 1 to 22, as well as Comparative Examples 1 to 4 are shown in Table 1 below.

### Preparation of External Additive

The tin oxide particles were prepared using hydrolysis in a way to obtain particles of appropriate size through appropriate pH control after dissolving the tin compound. The synthesized tin oxide particles were obtained through washing, drying, calcination, coating, and drying processes.

Aluminum oxide particles were obtained through thermal decomposition of aluminum chloride (AlCl₃) and are used as external additives after surface treatment.

Silica-polymer composite particles were produced through the polymerization reaction of colloidal silica and acrylic monomer and processed by hydrophobic surface treatment. The final silica-polymer composite was prepared by washing, filtering, drying, and pulverizing of the synthesized particles. As a silica-polymer composite, ATLAS™ SILICA COMPOSITE from CABOT was used.

To cover the surface of the dried toner core particles with external additives, 100 parts by weight of toner core particles were put into a powder mixer (KM-LS2K, Daehwa Tech, Korea), and then external additives were added according to each weight described in the Examples according to this disclosure. External added toner particles were prepared by mixing at about 2000 rpm for 30 seconds and additional mixing at about 6000 rpm for 3 minutes in a powder mixer of 2 L volume vessel.

### Preparation of a Toner

The chemical toner core particles were prepared by an aggregation method. The aggregation method may be performed by, for example, aggregating particles after mixing a binder resin dispersion, a colorant dispersion, and a releasing agent dispersion, and by combining the resulting aggregation.

The toner core particles include a binder resin, a colorant, and a releasing agent. As discussed forgoing, the binder resin may be, for example, styrene resin, acrylic resin, vinyl resin, polyether polyol resin, phenol resin, silicon resin, polyester resin, epoxy resin, polyamide resin, polyurethane resin, polybutadiene resin, or a mixture thereof. The colorant may be, for example, black colorant, yellow colorant, magenta colorant, cyan colorant, or a combination thereof. The releasing agent may be, for example, a polyethylene-based wax, a polypropylene-based wax, a silicon-based wax, a paraffin-based wax, an ester-based wax, a carnauba-based wax, a metallocene-based wax, or a mixture thereof.

TABLE 1

| | | | | | Silica- |
|---|---|---|---|---|---|
| | | | | | Polymer |
| | Tin Oxide | | Aluminum oxide | | composite |
| | Particle | Amount | Particle | Amount | Amount |
| | Size | (parts by | Size | (parts by | (parts |
| | (nm) | weight) | (nm) | weight) | by weight) |
| Example 1 | 28 | 1.8 | 13 | 0.8 | 1.5 |
| Example 2 | 28 | 1.8 | 13 | 0.05 | 1.5 |
| Example 3 | 28 | 1 | 13 | 0.8 | 1.5 |
| Example 4 | 28 | 1 | 13 | 0.8 | 0.6 |
| Example 5 | 28 | 0.2 | 13 | 0.8 | 1.5 |
| Example 6 | 28 | 1.8 | 13 | 0.4 | 1.5 |
| Example 7 | 28 | 1.8 | 13 | 0.4 | 0.6 |
| Example 8 | 28 | 1 | 13 | 0.4 | 3 |
| Example 9 | 28 | 1 | 13 | 0.4 | 1.5 |
| Example 10 | 28 | 1 | 13 | 0.4 | 0.6 |
| Example 11 | 84 | 1.8 | 13 | 0.8 | 1.5 |
| Example 12 | 84 | 1 | 13 | 0.8 | 1.5 |
| Example 13 | 84 | 1 | 13 | 0.4 | 1.5 |
| Example 14 | 84 | 1 | 13 | 0.4 | 3 |
| Example 15 | 28 | 1 | 45 | 0.8 | 1.5 |
| Example 16 | 28 | 1 | 45 | 0.4 | 1.5 |
| Example 17 | 28 | 1 | 80 | 0.8 | 1.5 |
| Example 18 | 28 | 1 | 80 | 0.4 | 1.5 |
| Example 19 | 214 | 1.8 | 13 | 0.8 | 1.5 |
| Example 20 | 28 (N.T*) | 1 | 13 | 0.4 | 1.5 |
| Example 21 | 28 | 1 | 160 | 0.8 | 1.5 |
| Example 22 | 28 | 1 | 160 | 0.4 | 1.5 |
| Comparative | — | 0 | 13 | 0.8 | 1.5 |
| Example 1 | | | | | |
| Comparative | 28 | 1.8 | — | 0 | 1.5 |
| Example 2 | | | | | |
| Comparative | — | 0 | — | 0 | 1.5 |
| Example 3 | | | | | |
| Comparative | 214 | 1.8 | — | 0 | 1.5 |
| Example 4 | | | | | |

N.T*: Not treated by hydrophobic silane coupling agents

### Measurement Method and Result of X-ray Fluorescence Spectrometry (WD-XRF)

The Tin intensity [Sn] and Aluminum intensity [Al] of the toner were measured by XRF according to the following procedure. The XRF measurement method performed analysis between 50 s in Ti-U mode and 50 s in Na—Sc mode using EDX-720 equipment.

The measured sample molding weight was 2.5 g±0.01 g, and the Tin content, Aluminum content, and Silicon content were determined using the intensity (unit cps/μA) obtained from this X-ray fluorescence spectrometry (WD-XRF).

The result of the measurement of examples and comparative examples are shown in Table 2 below:

TABLE 2

| | XRF intensity | XRF intensity | XRF |
|---|---|---|---|
| | of Sn | of Al | ratio |
| Example 1 | 65.89 | 19.52 | 3.38 |
| Example 2 | 65.89 | 1.03 | 63.96 |
| Example 3 | 36.6 | 19.52 | 1.88 |
| Example 4 | 36.6 | 19.52 | 1.88 |
| Example 5 | 7.32 | 19.52 | 0.37 |
| Example 6 | 65.89 | 11.05 | 5.96 |
| Example 7 | 65.89 | 11.05 | 5.96 |
| Example 8 | 36.6 | 11.05 | 3.31 |
| Example 9 | 36.6 | 11.05 | 3.31 |
| Example 10 | 36.6 | 11.05 | 3.31 |
| Example 11 | 44.81 | 19.52 | 2.3 |
| Example 12 | 24.12 | 19.52 | 1.24 |
| Example 13 | 24.12 | 11.05 | 2.18 |
| Example 14 | 24.12 | 11.05 | 2.18 |
| Example 15 | 36.6 | 13.2 | 2.77 |
| Example 16 | 36.6 | 7.71 | 4.75 |
| Example 17 | 36.6 | 9.05 | 4.04 |
| Example 18 | 36.6 | 6.09 | 6.01 |
| Example 19 | 11.88 | 19.52 | 0.61 |
| Example 20 | 35.88 | 11.05 | 3.25 |
| Example 21 | 36.6 | 5.28 | 6.93 |
| Example 22 | 36.6 | 3.03 | 12.08 |
| Comparative Example 1 | 0 | 19.52 | — |
| Comparative Example 2 | 65.85 | 0 | — |
| Comparative Example 3 | 0 | 0 | — |
| Comparative Example 4 | 11.88 | 0 | — |

### Evaluation of Results and Measuring Method

The result of the external additives was evaluated in view of (1) charging property according to the environment, (2) transfer property, (3) development property, (4) OPC background, and (5) durability.

### (1) Charging Property

The charging property was evaluated by EPPING Q/M (charge to mass) data at high-temperature (HH) and low-temperature (LL).

The EPPING Q/M meter was used as a measuring instrument and evaluated using the following procedures under conditions with a voltage of 105 V and an air flow rate of 2.0 L/min.

The sample was prepared by mixing 0.5 g of toner and 9.5 g of carrier in a 200 cc bottle and mixing it with a TURBULAR mixer for three minutes.

After the sample was left unattended in low-temperature (LL) conditions (10° C., relative humidity 10%) and high-temperature (HH) conditions (30° C., relative humidity 80%, relative humidity 80%) respectively, Q/M evaluation was carried out, and the Q/M amount in each environment was evaluated based on the following criteria.

### Evaluation Criteria

⊚: Excellent, HH/LL Q/M ratio 80% or more
ο: Good, HH/LL Q/M ratio 70% or more and less than 80%
Δ: Acceptable, HH/LL Q/M ratio 60% or more and less than 70%
X: Bad, HH/LL Q/M ratio 60% or less

### (2) Transfer Property

Transfer property was evaluated by measuring transfer efficiency in two phases.

A transfer efficiency assessment was conducted using a A4 color printer (Samsung Electronics, CLP-680).

The transfer efficiency evaluation was divided into 1st and 2nd as follows. The 1st transfer efficiency was measured using the weight of toner per unit area on OPC (Organic Photo Conductor) and the weight ratio of toner per unit area on intermediate transfer unit (ITB, Intermediate Transfer Belt) after transfer of toner from OPC to intermediate transfer unit.

In addition, 2nd transfer efficiency was evaluated using the weight ratio of toner per unit area on intermediate transfer unit and the weight ratio of toner per unit area on paper.

At this time, the weight of toner per unit area on the paper was measured by using unfused images.

The ratio was presented in a percentage.

$$First evaluation :$$

$$The {1}^{st} transfer efficiency = ( the weight of the toner ( mg ) per unit area on \text{} ITB \text{} / the weight of the toner ( mg ) per unit area on OPC )$$

$$Second evaluation :$$

$$The {2}^{nd} transfer efficiency = ( the weight of the toner ( mg ) per unit area on the \text{} paper / the weight of the toner ( mg ) per unit area on ITB )$$

$$Final transfer efficiency = ( {1}^{st} transfer efficiency \times {2}^{nd} transfer efficiency ) \times 100 ( \% )$$

The final transfer efficiency is obtained as a percentage value by multiplying the result values of the first evaluation and the second evaluation. The unit area is an arbitrary area designated by the evaluator.

### Evaluation Criteria:

⊚: Excellent, Transfer efficiency of 90% or more
ο: Good, Transfer efficiency of 80% or more, and of less than 90%
Δ: Acceptable, Transfer efficiency of 70% or more, and of less than 80%
X: Transfer efficiency of 60% or more and of less than 70%

### (3) Development Property

A development property was evaluated by a percentage by dividing the weight of the toner on OPC by the weight of the toner on DR (Development Roller), after printing 1000 pages.

$$Development property = ( the weight of the toner ( mg ) per unit area on OPC \text{} / the weight of the toner ( mg ) per unit area on DR ) \times 100$$

A development property was conducted using a A4 color printer (Samsung Electronics, CLP-680). After printing 1,000 sheets, before the toner moves from the OPC to the intermediate transcription, a certain area of image is developed on the OPC, and the toner weight on the OPC is measured using a filter-attached suction device.
At this time, the weight of toner per unit area on the developer roller was measured simultaneously and the development efficiency was evaluated in the following manner.

### Evaluation Criteria

⊚: Excellent, Development efficiency 90% or more
ο: Good, Development efficiency 80% or more and less than 90%
Δ: Acceptable, Development efficiency 70% or more and less than 80%
X: Bad, Development efficiency 60% or more and less than 70%

### (4) OPC Background

OPC background was evaluated by optical density after OPC tapping of non-image area

A development property was conducted using a A4 color printer (Samsung Electronics, CLP-680). After printing 1,000 sheets, the optical density of three points was measured by taping the non-image area of the OPC drum to determine its mean.

Optical density was measured using an “Electroeye” reflective concentration meter. It is classified according to the criteria for performing OPC background pollution prevention.

### Evaluation Criteria

⊚: Excellent, OD (Optical density) less than 0.01
ο: Good, OD (Optical density) 0.01 or more and less than 0.03
Δ: Acceptable, OD (Optical density) 0.03 or more and less than 0.05
X: Bad, OD (Optical density) 0.05 or more

### (5) Durability

Durability was evaluated by variation of image density compared to the initial at 5000 page.

Durability was conducted using a A4 color printer (Samsung Electronics, CLP-680). The image density deviation was measured per 1,000 sheets and the degree of variation was evaluated compared to the initial image density as the number of prints increases.
The results of the measurement were classified according to the criteria below.

### Evaluation Criteria

⊚: Excellent, Variation of image density less than 10%
ο: Good, Variation of image density 10% or more and less than 20%
Δ: Acceptable, Variation of image density 20% or more and less than 30%
X: Bad, Variation of image density 30% or more and less than 40%

The result of the evaluation in each area as mentioned above was shown in Table 3 below:

TABLE 3

| | Charging | | | | |
|---|---|---|---|---|---|
| | property | | | | |
| | according | | | | |
| | to | | Develop- | OPC | |
| | environ- | Transfer | ment | Back- | |
| | ment | property | property | ground | Durability |
| Example 1 | ◯ | ⊚ | ◯ | Δ | ⊚ |
| Example 2 | ⊚ | Δ | ◯ | ⊚ | ◯ |
| Example 3 | ⊚ | ⊚ | ◯ | Δ | ⊚ |
| Example 4 | ⊚ | ◯ | ◯ | Δ | ◯ |
| Example 5 | Δ | ◯ | ◯ | Δ | ◯ |
| Example 6 | ◯ | ⊚ | ◯ | ◯ | ⊚ |
| Example 7 | ◯ | Δ | ◯ | ◯ | ◯ |
| Example 8 | ⊚ | ⊚ | ⊚ | ◯ | ⊚ |
| Example 9 | ⊚ | ⊚ | ◯ | ◯ | ⊚ |
| Example 10 | ⊚ | Δ | ◯ | ◯ | ◯ |
| Example 11 | ◯ | ◯ | ◯ | Δ | ⊚ |
| Example 12 | ⊚ | ◯ | ◯ | Δ | ◯ |
| Example 13 | ◯ | Δ | ◯ | ◯ | ◯ |
| Example 14 | ◯ | ◯ | ◯ | ◯ | ⊚ |
| Example 15 | ◯ | ◯ | ◯ | Δ | ◯ |
| Example 16 | ◯ | Δ | ◯ | ◯ | ◯ |
| Example 17 | ⊚ | Δ | Δ | ◯ | ⊚ |
| Example 18 | ◯ | Δ | Δ | ◯ | ◯ |
| Example 19 | Δ | ◯ | Δ | X | ◯ |
| Example 20 | X | Δ | Δ | ◯ | Δ |
| Example 21 | Δ | X | Δ | ◯ | ◯ |
| Example 22 | ◯ | X | Δ | ⊚ | ◯ |
| Comparative | X | ◯ | Δ | Δ | Δ |
| Example 1 | | | | | |
| Comparative | X | Δ | Δ | Δ | ◯ |
| Example 2 | | | | | |
| Comparative | X | X | X | ⊚ | Δ |
| Example 3 | | | | | |
| Comparative | X | Δ | Δ | ◯ | ◯ |
| Example 4 | | | | | |

Referring to tables 2 and 3, when the external additives comprise tin oxide, aluminum oxide, and silica-polymer composite, the toner exhibits good results in all evaluated fields (charging property according to the environment, transfer property, development property, OPC background and durability). In contrast, examples omitting at least one element among tin oxide, aluminum oxide, and silica-polymer composite have bad results in at least one evaluated field.

Moreover, when the particle size of tin oxide ranges within about 10 nm to 100 nm, the particle size of aluminum oxide ranges within about 7 nm to 160 nm, and/or the particle size of silica-polymer composite ranges within less than 110 nm, a better result could be obtained.

Particularly, when the particle sizes of tin oxide satisfy 84 nm or less, an excellent result was obtained in the field of characteristics of charge and durability. The best performance was obtained by controlling the size and amount of tin oxide as the condition presented in example 6.

In addition, as shown in the examples, when the size of the tin oxide was of less than 200 nm, better performance could be obtained by adding the aluminum oxide.

Furthermore, when the tin oxide was modified on the surface, better performance could be obtained.

As presented in the comparative examples 1 to 4, when a single one of the tin oxide and aluminum oxide was used, a good result could not be obtained, especially in the field of charging property according to the environment.

Meanwhile, when the aluminum oxide was used in the amount of 0.4 parts by weight based on 100 parts by weight of the core particle, the result of OPC background was found to be better.

Moreover, when the particle size of aluminum oxide was the same or less than 150 nm, the desired performance could be effectively obtained. Moreover, the transfer property decreased as the particle size of aluminum oxide increased.

Furthermore, it was found that the performance of the external additives correlate with the XRF intensity. Particularly, the results in all evaluated fields were good when the ranged ratio of XRF in examples satisfies between 0.4 and 64.

The best performance of the additives was obtained when the tin oxide, aluminum oxide, and silica-polymer composite of the external additive were met by the ranged size and the ranged XRF intensity together.

While examples have been described above, it will be understood by those of ordinary skill in the art that various changes in form and details may be made therein without departing from the scope as defined by the following claims.

1. An external additive for a toner, the external additive comprising tin oxide, aluminum oxide, and silica-polymer composite.

2. The external additive according to claim 1, whereby the tin oxide is a hydrophobized tin dioxide.

3. The external additive according to claim 1, whereby an average primary particle diameter (D50) of the tin oxide ranges from 10 nm to 100 nm.

4. The external additive according to claim 1, whereby an average primary particle diameter (D50) of the aluminum oxide ranges from 7 nm to 80 nm.

5. The external additive according to claim 1, whereby an average primary particle diameter (D50) of the silica-polymer composite ranges from 110 nm or less.

6. The external additive according to claim 1, the external additive further comprising silica.

7. The external additive according to claim 6, the silica comprising a fumed silica and a sol-gel silica.

8. A toner comprising:
a core particle including a binder resin, a colorant, and a releasing agent; and
an external additive attached to a surface of the core particle including tin oxide, aluminum oxide, and silica-polymer composite.

9. The toner according to claim 8, whereby an average primary particle diameter (D50) of the tin oxide ranges from 10 nm to 100 nm.

10. The toner according to claim 8, whereby an average primary particle diameter (D50) of the aluminum oxide ranges from 7 nm to 80 nm.

11. The toner according to claim 8, whereby an average primary particle diameter (D50) of the silica-polymer composite ranges from 110 nm or less.

12. The toner according to claim 8, whereby a ratio of an X-ray fluorescence intensity of the plurality of the toner particles measured by a wavelength dispersive X-ray fluorescence (WD-XRF) spectrometry satisfies the following condition:
$$0.4 \leq [ Sn ] / [ Al ] \leq 64 ;$$
wherein [Sn] is an X-ray fluorescence intensity of tin oxide measured by the WD-XRF spectrometry of the plurality of the toner particles, and [Al] is an X-ray fluorescence intensity of aluminum oxide measured by the WD-XRF spectrometry of the plurality of the toner particles.

13. The toner according to claim 8, whereby a ratio of an X-ray fluorescence intensity of the plurality of the toner particles measured by X-ray fluorescence (WD-XRF) spectrometry satisfies the following conditions:
$$0.07 \leq [ Sn ] / [ Si ] \leq 3.2 ; and$$
$$0.01 \leq [ Al ] / [ Si ] \leq 0.81$$
wherein, [Sn] is an X-ray fluorescence intensity of tin oxide [Sn], [Si] is an X-ray fluorescence intensity of silica, and [Al] is an X-ray fluorescence intensity of aluminum oxide.

14. The toner according to claim 8, the external additive further comprising silica.

15. A cartridge for developing an electrostatic latent image, the cartridge comprising a toner, the toner comprising:
a core particle including a binder resin, a colorant, and a releasing agent; and
an external additive attached to the core particle, the external additive comprising tin oxide, aluminum oxide, and silica-polymer composite.
